(19) United States
(12) Patent Application Publication
(10) Pub. No.: US 2001/0018711 A1
(43) Pub. Date: Aug. 30, 2001

(54) Data communication

(75) Inventor: Donal Morris, Ashbourne (IE)

Correspondence Address: LAW OFFICE OF BARRY R LIPSITZ, 755 MAIN STREET, MONROE, CT, 06468, US

(73) Assignee: Sherkin Communications Limited, Ashbourne (IE)

(21) Appl. No.: 09/736,588

(22) Filed: Dec. 13, 2000

(30) Foreign Application Priority Data
Dec. 13, 1999 (IE) S1999/1037

(51) Int. Cl. G06F 15/16

(52) U.S. Cl. 709/229; 709/227; 709/203

(57) ABSTRACT

A method of communication of control information between data processing systems in a multiservices network via a communications channel. The method performs the steps of receiving a session initiation stimulus at a Session Control System(SCS), authenticating the received initiation stimulus in the SCS by referencing the stimulus source and stimulus content to a requested service and generating a proceed signal to a multiservices provider on receipt of an authentication valid signal from a contract database associated with the SCS and generating a service event. In this way, data can be controlled and organized in an ‘a priori’ and sequenced manner for the purposes of generation of information to charge directly or bill a customer.

The invention relates to communication of data between data processing systems and in particular to the communication of control information in a multiservices network.

The explosive growth in recent times of data communication across certain networks has offered millions of individuals and businesses access to a vast array of services. The ability of service providers to accurately control and monitor the spectrum of services that they may offer has unfortunately, not matched this pace of development The cost and complexity of providing these services is significant and therefore it is vital that such services are accurately monitored and controlled. Commercially, in order to attract and retain service users it is vital that the provider can offer a competitive pricing structure. In the telecommunications industry the introduction of ‘to the second billing’ rather than the purchasing of time units of preset length has proven extremely popular with service users. While this was undoubtedly of great benefit to service providers it takes no account of the users individual details or of the type of service being used and is therefore not suited to a multiservices network environment.

Multiservices networks provide various types of transport services using a variety of network technologies such as switched and permanent Asynchronous Transfer Mode technology, Frame Relay, Integrated Services, Differentiated Services and Multi-Protocol Label Switching. Various access network technologies may also be used is providing access to multiservice networks. These could be variants of the following: Ethernet, Fast Ethernet, Gigabit-Ethernet, various Digital Subscribers Line types, various satellite access types, Public Switched Telephone Network and Integrated Subscriber Digital Network. The technologies operate to provide end to end quality of service guarantees supporting a transport service that may be invoked by a user or a user system. Multiservices networks of these types offer far more to users as they use methods of reserving resources, which enable end to end guarantees to be provided to a customer.

Having provided these services it is vital given the costs involved that the use of these services is organised, monitored and controlled and where appropriate billed. In order for a billing system to work it is necessary to co-relate tariff information, customer information, resource and usage information. Solutions for billing in the telephone network have relied on timing details and have not differentiated by service type. For example many telephone networks do not charge differentially if the call is a voice or fax call. Proposed solutions thus far have relied on timing details or events. Some proposed solutions have considered measuring used or reserved resources but have limitations in linking the tariff to the service and the customer. This solution organises all the necessary information bindings a prior and provides significant flexibility, scalability and processing improvement over a posteriori solutions.

Service is an important feature of the current invention. In a traditional telephone network the standard service is point-to-point interactive voice. A multi-service network such as designed in the current invention has more flexible service types including: content, data, voice, image or video; communicated using mode types such as: interactive, distribution, retrieval or messaging; and also using network topology types such as point to point, point to multi-point, multi-point to point; or multi-point to multi-point; in symmetrical or asymmetrical bandwidth modes.

There is therefore a need for an apparatus and method of data communication, which will overcome the aforementioned problems and which will supply Internet users with a choice of multimedia services in terms of voice, video and fast data services to fully exploit the potential of the Internet and associated software applications. Additionally, there is a need for such a method and apparatus, which will allow service providers to commercially exploit data traffic and particularly voice traffic.

Accordingly, the invention provides a data communication method carried out by mutually remote data processing systems, the method comprising the step of transmitting data between the systems via a communications channel, wherein the method comprises the further steps of:

receiving a session initiation stimulus at a Session Control System(SCS);

authenticating the received initiation stimulus in the SCS by referencing the stimulus source and stimulus content to a requested service;

generating a proceed signal to a multiservices provider on receipt of an authentication valid signal from a contract database associated with the SCS, the signal optionally including any or all of,

a content resource vector

a network resource vector

a service vector

a label indicating any of these vectors;

generating a timestamp to indicate session commencement

generating and passing a service vector signal to the network;

transmitting a connection end destination address to the network

receiving a connection established signal from the network to indicate connection to a content server;

receiving a content vector from the content server the content vector indicating the type of content and a flag for identifying the existence of a service component related to content; and

receiving a grade of service of multipath vector from the network to indicate the nature of the multi-party service for the purposes of billing if the service includes a multipath component

The generation of a timestamp to indicate for the purposes of billing that the path is available for use. This time stamp indicates the start of the session for the purposes of billing. The service vector may include: mode types such as interactive, distribution, retrieval or messaging; connection topology types such as point to point, point to multi-point; multi-point to point; or multi-point to multi-point; bandwidth mode types such as symmetrical or asymmetrical.

The modification of the service vector by the user or user system and the passing of the modified service vector to the network in order to increase or decrease the quality of the service and the magnitude of the resources used to deliver the service and to increase or decrease the tariff applied and hence adjust the tariff.

The process of checking with an authorization system if the modification can be accepted as the user or end user system may have different authorization criteria for the modification.

The method of the invention allows calculation of a charge per Internet service event in a very flexible way by operating between a network control layer and a service provider's billing system. It links end user demands with the network capability and with the service provider's billing system. Additionally, it is formed for operation with next generation network technology, MPLS (Multi-protocol label switching). The method of the invention allows for the automatic restructuring of service providers business models to capitalise on existing potential as well as facilitating the creation of new Internet services. It does this in a way that also allows the provider to manage end user access to services and give the end user a choice of services. In this way high quality services on the network are provided on-demand, in real-time and with an accurate charge per service and per usage.

In one arrangement, the service event or session is linked to:

a customer price quote;

service brand and service characteristics;

a service category;

an element of the service related to service differentiation

a service differentiated architecture;

the network resource vector;

the service vector;

the network equipment and associated operation support systems;

the customer software or customer hardware or other customer premises equipment;

the path or set of paths;

the content resource vector;

the multipath vector; and

the SDR or component elements of the SDR

The use of service events allows the triggering of a service by the service user, the setup of the service using the service vector (traffic part) by the service gateway, the use of the service by the service user, the application of the service vector (tariff part) and timestamped service usage information from the service gateway allowing the creation of a charge record.

By treating service events in this way the invention allows for the creation of particular service events, the creation of such events where bandwidth is an ingredient and where content is also an ingredient. It also facilitates the implementation of a business model based on these service events where price, promotion, and distribution place are part of the model.

In a preferred embodiment, the method incorporates the steps of:

receiving from the network a signal to indicate that the path has been modified; and

automatically generating a timestamp to indicate that the path has been modified.

This indicates to the billing system the start of a sub-session for the purposes of billing.

Ideally, the method incorporates the further step of receiving a session termination stimulus at the Session Control System (SCS).

This maybe from the network, the user, the user system, the network management system, the network element management or the service and management system.

Preferably, the generation of a timestamp to indicate for the purposes of billing the end of the session is based on the session termination stimulus.

In a preferred arrangement, the generation of a session detail record (SDR) for the purposes of billing triggers the generation of a charge record.

In one arrangement, the SDR or component elements of the SDR are linked to a label of multi-protocol label switching (MPLS).

In another arrangement, the MPLS label is linked to one or all of: a customer price quote,;

a service brand and service characteristics;

a service category;

an element of the service related to service differentiation;

a service differentiated architecture;

a network resource vector;

a service vector;

network equipment and associated operation support systems;

customer software or customer hardware or other customer premises equipment;

a path or set of paths;

a session control system;

a content resource vector; and

a multipath vector.

The ULPS label is so linked to provide the invention with the functional capacity for service creation and control as well as enabling service access, between a customer or customers' agent and a service provider. It also provides for customer authentication and customer contracting in a commercial or resource manner while enabling a bandwidth business model while trading bandwidth or trading bandwidth based services. The method also provides for the generation of a service detail record and a charge record for the purposes of billing

Preferably, the method incorporates the step of passing a label from a service control system to a customer system for:

service contracting;

service enabling;

service or customer authentication;

service or customer authorization;

service or customer management; and

service or customer billing.

Ideally, the method incorporates the step of passing the label to a customer protocol stack, device driver or other aspect of the customer premises equipment for the purposes of enabling the process.

The invention allows for the generation of tariff and service management information for the purposes of billing on a multiservices network which in one arrangement may be for use on the Internet.

The current invention makes use of a service vector based on naming information, descriptive information and network or content resource information and is of particular importance for billing-tariff information.

The invention also makes use of content resource vector including the names, the types, coding techniques and value categories of still images and moving images.

It is an important feature of the current invention that the network resource vector includes traffic control device parameters flowspecs and flow rates.

The network resource vector may optionally include any of the following non-exhaustive list of parameters: rate, bucket size, peak rate, minimum policed unit, peak data rate, peak burst size, committed data rate, committed burst size, excess burst size, weight, frequency, cell loss ratio, cell transfer delay, maximum cell transfer delay, cell delay variation, cell delay variation tolerance, sustainable cell rate, maximum burst size, minimum cell rate, per bop behaviors, per bop behavior scheduling classes, differentiated service code points, traffic conditioners for metering, policing, shaping or packet marking behavior aggregates, forward equivalence classes, peak cell rate, maximum frame size and queuing mechanism parameters.

The network resource vector may also use other parameters, which characterise the resources used or reserved in a multiservices network.

According to one aspect of the invention, there is provided a method for processing data generated for traffic engineering purposes by accessing finctionality or data produced through a traffic engineering applications programming interface and delivering traffic engineering data over an external data interface.

Ideally, a traffic engineering unit from the interface is linked to:

the Label;

the content resource vector;

the service vector;

the Network resource Vector;

the session;

a customer;

a customer signature; and

a multi-path vector.

The generation of a tariff vector which is a monetary function of any combination of the parameters of the service vector, the content resource vector or the network resource vector.

A number of solutions to overcome the limitations described above have been proposed. For example U.S. Pat. No. 5,600,643 Robrock, identifies a system, which generates billing data based on network use. The specification also describes a service creation program, which may be downloaded to the customer from the network, and used by the customer to create a new service script, which is subsequently downloaded to the network for execution. While this document refers to billing information and virtual circuits, it makes no link binding service, network resources, tariff or session parameters. Therefore, it does not contain the complete information set for generating charge record information for network services based on a multiservice platform. No reference is made to tariffs or network resources such as those managed by traffic control or traffic contract devices in network.

U.S. Pat. No. 5,912,954 Whited et al. identifies a method for generating billing information for a call in a telecommunications network using a billing information tag and customer billing information. While providing a useful billing methodology and showing the use of intelligent networks it only identifies a service control system. It does not identify a method of defining or creating services nor does it link the billing information to tariff information for the service. The patent identifies ‘call detail records’ but does not recogise linking this type of detail record to the customer in the context of: tariff information, content information, service information for the purposes of service and tariff differentiation, network resource information or content information.

U.S. Pat. No. 5,953,334 Morita, et al. shows another proposed solution with an ATM switching system. This document, while describing a method of ‘counting a quantity of transmitted ATM cells’ for the purposes of ‘notifying the count value as charging data’ does not indicate a method of defining a service does not indicate a method of relating the count to a tariff structure or a service structure. Furthermore, the patent makes no reference, for the purposes of billing, to a system component, for determining the customer or user. The patent makes no reference to the determination of resources used or resources reserved by calculation methods including data rates and duration intervals. In addition the patent makes no reference to time based charging or time and volume based charging.

None of these system attempt to control or organize in an ‘a priori’ and sequenced manner, the service identification, the tariff structure, the customer access, the customer authorisation, the customer identification, the network resource control, the session S parameters (related to service session start, modification and termination), the coordination of that information for the purposes of generation information to charge directly or bill a customer.

The invention will be more clearly understood from the following description of an embodiment thereof given by way of example only, with reference to the accompanying drawings, in which:

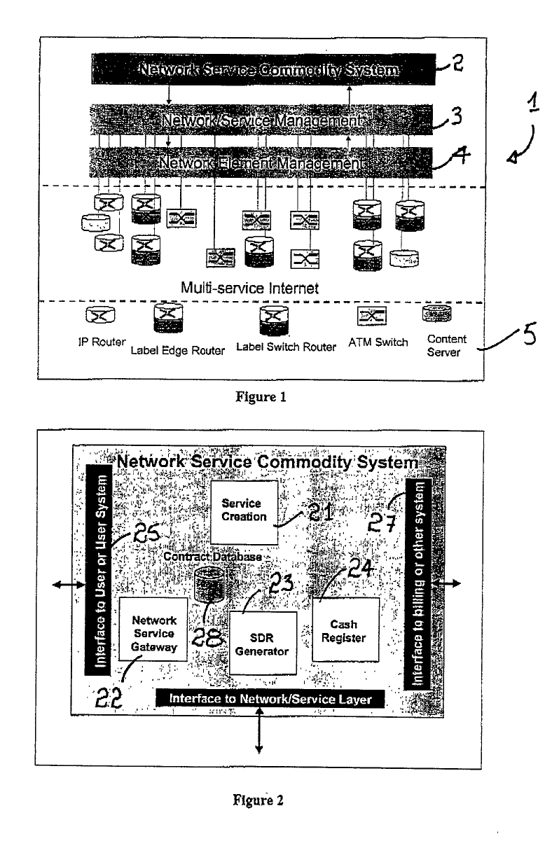

FIG. 1 is a diagrammatic view of a network hierarchy using a data communications method in accordance with the invention;

FIG. 2 is a block diagram of a network commodity system shown in FIG. 1;

FIG. 3 is a diagrammatic view of a service creation function forming part of the invention;

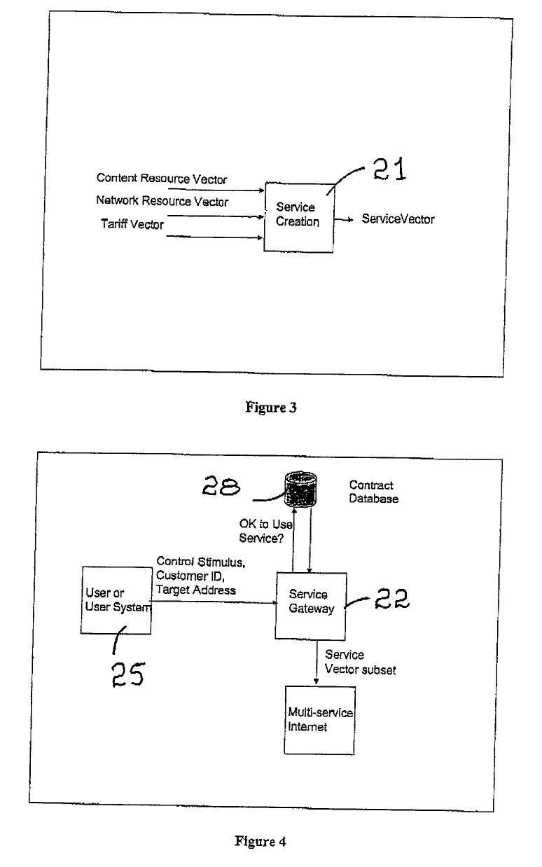

FIG. 4 is a diagrammatic view of a user stimulus operation forming part of the invention;

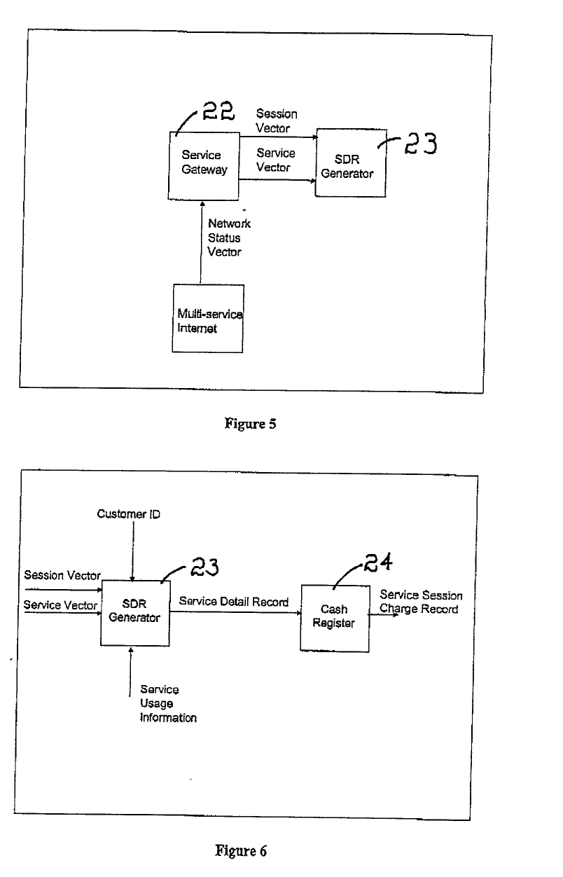

FIG. 5 is a diagrammatic showing operation of a network service gateway operating in accordance with the invention; and

FIG. 6 is a view similar to that of FIG. 5 showing operation of the Cash Register and SDR generator.

Referring to the drawings and initially to FIG. 1, there is shown a communication system using the method and apparatus of the invention indicated generally by the reference numeral 1 for use with a multiservices network. To aid understanding of the current invention, operation is described with relation to one such network, namely the Internet, however, it will be appreciated that the invention may be equally applied to many other networks and is not dependent on functionality of the Internet.

The communications system 1 has a network service commodity system layer 2 a network/service management layer 3, and a network element management layer 4. It will be understood that the nature of the layers 3,4 may be changed in different implementations without altering the nature of the invention. For example, the network may not have a network element management layer or the functions of network management and service management may be separated. The layers 2,3,4 sit on a multiservice network having individual elements providing a multiplicity of network services. The network service commodity system provides control signals and receives information from lower layers that ultimately control network elements. These lower layers may be the network element management layers 3, Network Management Layers or Service Management Layers 4, The Multiservices Internet may be any interconnected arrangement of Internet Protocol routers, Label Edge Routers, Label Switch Routers, Asynchronous Transfer Mode switches and content servers indicated generally at 5.

In more detail and referring now in particular to FIG. 2 the network service commodity system layer 2 has a service creation function 21 a network service gateway 22 a session detail record generator 23, a cash register 24, a user system interface 25, a network/service interface 26, a billing or external system interface 27 and a contract database 28. The operation of the various components will be now generally described with reference to specific detail thereafter.

A remote user generates a stimulus by requesting access to or use of a particular service. This generated stimulus is received through the interface 25 and is passed to the service creation function 21 to generate a service vector. The service vector contains the user identification, service type, and address of the requested service. This stimulus is transmitted and is then mapped into the contract database 28. The stimulus is authorised by cross referencing the user identification, service type against the authorised configuration and in response to an authorisation single generates a network configuration signal trough the gateway 22. This network configuration signal passes the control information to the network, namely to the switch and associated resource 5.

If, for example, the requested services related to data on the contents server 5, the generated stimulus would specify the address of the contents server 5. Once the stimulus has been authorised the control signals would be sent to both the switch and contents server having first obtained these signals by referencing the traffic content type. The route by which these control singles are sent will depend on the network configuration and may be sent to any or all of the network manager, service manager, the element manager or even to the individual elements.

Once the control signals have been sent to the switch and content server 5 the connection is established. The content server then returns a label-mapping message with path details to the original stimulus requester. This label-mapping message will set out in detail the route from the stimulus generator or user to the contents server along which data being transmitted will follow. An essential feature of this invention is that at this time, namely the moment of establishment of connection is when the time stamp is generated and a record is kept of traffic passing between the contents server and the stimulus requester. By carefully monitoring the circuit until an end-time stamp signing the end of transmissions between the two processing elements is received, an accurate and controllable billing process is possible. As the billing process will reference both the type of connection and the identity of the user an appropriate billing level may be applied.

It will of course be understood that it is within the scope of this invention that during transmission of data following the establishment of a connection the user may generate a further stimulus to change the session configuration mid session. That is to say if a user were using services at a normal level the may choose to upgrade the level of service and the guarantees therein implied mid session. This may involve reconfiguration of the circuit between the user and the resource being used or may involve the allocation of additional resources along the data transmission path. The duration of this modification may then also be billed as an amendment time stamp is also noted for processing by the cash register 24. As the service provider can monitor accurately the services being used a detailed, accurate and reliable bill can be provided. It will be understood that the implementation of a cash register process at distributed points in the network can be associated with centralised process or network edge based processing. The cash register receives Service User Identity information and Service Event Timestamp information, which it combines S with the Service Vector (Tariff Part) to create a charge record for the service event, which can be used as the input to a bill for the service user. Thus, the invention allows for the calculation of a monetary charge to recover for an operator value based on the data elements described. The physical location of such a cash register may be on a distributed basis. Such distribution may be: customer based, point of presence (POP) based, access network based, distribution network based, core network based or otherwise.

It will also be understood that the invention anticipates the use of cell count information within the traffic context for certain information and/or applications.

The SDR 23 described above may optionally be formed including:

the timestamp to indicate the start of the session;

the timestamp to indicate the modification of the session;

the customer signature;

the customer vector;

the service vector;

the content resource vector;

the network resource vector;

the multipath vector;

the timestamp to indicate the end of the session;

the duration of the session;

the duration of the sub-session.

It will be appreciated that it is possible to store a single or multiple SDRs in a database for access by another system and that these may be put in an event channel for distribution to the other system.

It is an important feature of the invention the billing is determined from the charge record generated by processing a calculation formula, depending on the service and any of the following parameters:

the session vector;

the SDR;

the customer vector;

the service vector;

the network resource vector;

the content resource vector;

the multipath vector;

the value of the timestamp, which indicates the start of the session;

the value of the timestamp, which indicates the modification of the session;

the value of the timestamp which indicates end of the session; and

the tariff vector

The formula mentioned above may be structured such that any of the parameters of the SDR are arranged in a matrix with n×m dimensions and the formula is expressed as mathematical manipulation on any elements in the matrix. This enables easy implementation of the cash register by a spreadsheet application.

It will be understood that the generation of a service session charge record is based on the SDR and the tariff vector.

It will be noted that the session vector may optionally include:

a service identification label;

a value of the timestamp, which indicates the start of the session;

a value of the timestamp which indicates the modification of the session; and

a value of the timestamp, which indicates end of the session.

The session vector is instantiated either automatically, on the receipt of a control stimulus from the user or user system or on receipt of a network status vector, which indicates tat the network connection has been established.

A session vector is created by stimulus from an end user or from an application. The session vector contains any of the parameters of the service vector plus a flag to indicate that the session has been authorised.

The method described by also incorporate receiving from the network, status information relating to connection status. The network status vector may optionally, include:

a label Mapping Message;

a label Release Message; and or

a label Withdraw message.

The method described allows for signaling to the network the type of service, class of service, the quality of service or the grade of service required by the user or user system. Passing to the network element the network resource vector.

For a Multiprotocol Label Switched network this vector could include a traffic type length value(TLV) or the components elements required in a traffic TLV which are:

Frequency

Weight

Peak Data Rate

Peak Burst Size

Committed Data Rate

Committed Burst Size

Excess Burst Size

For an Asynchronous Transfer Mode network this vector could include amongst others

Peak Cell Rate

Sustainable Cell Rate

It will be her understood that the binding of a label to a data flow or other control system where that label has been processed by the communications system of the current invention may thus have the attributes of being:

Contracted

Linked to a Service Vector

Linked to a Customer

Linked to a Service Detail Record

It will be similarly understood that the Service Vector is a structured collection of parameters that define the service in terms of Market Brand, Traffic Data and Tariff Data. The Market Brand allows the value of the service to be proposed to prospective customers and after purchase is a reference for the continued use of the service. The Traffic Data allows the service gateway to configure the transport required for the service. The Tariff Data allows the cost of using the service to be proposed to prospective users and also allows a specific charge to be applied for each service event. The Service vector allows the grouping of these parameters in a manner that creates a service that can be offered, provided and for which a charge can be made.

It will of course be understood that the invention is not limited to the specific details herein described, which are given by way of example only, and that various modifications and alterations are possible with the scope of the appended claims.

1. A data communication method for operation between remote data processing systems, the method comprising the step of transmitting data between the systems via a communications channel having an associated path, characterised in that the method comprises the further steps of:
receiving a session initiation stimulus at a Session Control System(SCS);
authenticating the received initiation stimulus in the SCS by referencing the stimulus source and stimulus content to a requested service;
generating a proceed signal to a multiservices provider on receipt of an authentication valid signal from a contract database associated with the SCS and generating a service event.

2. A data communication method as claimed in claim 1 incorporating means for performing the additional steps of:
generating a timestamp to indicate session commencement
generating and passing a service vector signal to the network;
transmitting a connection end destination address to the network
receiving a connection established signal from the network to indicate connection to a content server;
receiving a content vector from the content server the content vector indicating the type of content and a flag for identifying the existence of a service component related to content; and
receiving a grade of service of multipath vector from the network to indicate the nature of the multi-party service for the purposes of billing if the service includes a multipath component.

3. A data communication method as claimed in claim 1 incorporating the further steps of:
detecting the generated service event;
triggering of a service by a service user associated with the service event,
initializing setup of the triggered service using a traffic part of a service vector associated with the service event by a service gateway;
monitoring use of the service by the service user;
application of a tariff part of the service vector and timestamped service usage information from the service gateway for creating a charge record.

4. A data communication method as claimed in claim 1 incorporating the further steps of:
receiving from the network a signal to indicate that the path has been modified; and
automatically generating a timestamp associated with the modifcation.

5. A data communication method as claimed in claim 1 having means for:
receiving a session termination stimulus at the Session Control System (SCS); and
generating of timestamp to indicate session termination in response to the received stimulus.

6. A data communications method as claimed in claim 5 wherein the received stimulus trigger generation of a session detail record (SDR) and the generation of a charge record.

7. A data communications method as claimed in claim 6 wherein the SDR is linked to a label of multi-protocol label switching (MPLS).

8. A data communications method as claimed in claim 1 incorporating the step of passing the label to a customer protocol stack of a customer system.

9. A data communications method as claimed in claim 1 using a service vector based incorporating naming information, descriptive information and network or content resource information.

10. A data communications method as claimed in claim 1 using a content resource vector incorporating a name, a type, coding techniques and value categories of still images and moving images.

11. A data communications method as claimed in claim 10 wherein tile resource vector includes traffic control device parameters and flow rates.

12. A data communications method for processing data generated for traffic engineering purposes by accessing functionality or data produced through a traffic engineering applications programming interface and delivering traffic engineering data over an external data interface.
